(19) United States
(12) Patent Application Publication
(10) Pub. No.: US 2026/0038093 A1
(43) Pub. Date: Feb. 5, 2026

(54) Automatic Identification of Distracting Vivid Regions in An Image

(71) Applicant: Google LLC, Mountain View, CA (US)

(72) Inventors: Orly Liba, Palo Alto, CA (US); Junfeng He, Fremont, CA (US); Bryan Eric Feldman, Millbrae, CA (US); Yael Pritch Knaan, Tel Aviv (IL); Kfir Aberman, San Mateo, CA (US)

(21) Appl. No.: 19/099,755

(22) PCT Filed: Jul. 29, 2022
(86) PCT No.: PCT/US2022/038839

§ 371 Date: Jan. 29, 2025

(51) Int. Cl. G06T 5/60; G06T 7/00; G06T 7/11; G06T 11/20

(52) U.S. Cl. CPC G06T 5/60; G06T 7/0002; G06T 7/11; G06T 11/206; G06T 2207/30201

(57) ABSTRACT

Methods and systems for modifying a digital image are described herein. The method can include performing vividness scoring for a plurality of pixels of the digital image, determining one or more candidate pixels based on the vividness scoring for the plurality of pixels, and agglomerating the one or more candidate pixels into one or more suggested agglomerates. The method can also include determining at least one subject of the digital image, removing at least one agglomerate from the one or more suggested agglomerates based on at least one of the at least one subject of the digital image or one or more characteristics of the at least one agglomerate, generating a modified digital image with the one or more suggested agglomerates modified, and outputting the modified digital image.

### FIELD

The present disclosure relates generally to digital image processing. More particularly, the present disclosure relates to the use of segmentation and other image analysis techniques to identify vivid regions in a digital image that can distract from the subject of the digital image.

### BACKGROUND

Various image modification techniques have been used in the past on digital images to identify regions in digital images. However, there is currently no method for identifying and reducing, removing, or otherwise modifying areas of vivid (e.g., overly bright or otherwise districting) colors in photographs, especially vivid colors that are not associated with the subject of the photograph, which can distract from said subject.

### SUMMARY

Aspects and advantages of embodiments of the present disclosure will be set forth in part in the following description, or can be learned from the description, or can be learned through practice of the embodiments.

One example aspect of the present disclosure is directed to a method of modifying a digital image. The method can include performing vividness scoring for a plurality of pixels of the digital image, determining one or more candidate pixels based on the vividness scoring for the plurality of pixels, and agglomerating the one or more candidate pixels into one or more suggested agglomerates. The method can also include determining at least one subject of the digital image, removing at least one agglomerate from the one or more suggested agglomerates based on at least one of the at least one subject of the digital image or one or more characteristics of the at least one agglomerate, generating a modified digital image with the one or more suggested agglomerates modified, and outputting the modified digital image.

Another example aspect of the present disclosure is directed to a computing system. The computing system can include one or more processors and a non-transitory, computer-readable medium. The non-transitory, computer-readable medium can include instructions that, when executed by the one or more processors, cause the one or more processors to perform a process. The process can include performing vividness scoring for a plurality of pixels of the digital image, determining one or more candidate pixels based on the vividness scoring for the plurality of pixels, and agglomerating the one or more candidate pixels into one or more suggested agglomerates. The process can also include determining at least one subject of the digital image, removing at least one agglomerate from the one or more suggested agglomerates based on at least one of the at least one subject of the digital image or one or more characteristics of the at least one agglomerate, generating a modified digital image with the one or more suggested agglomerates modified, and outputting the modified digital image.

Another example aspect of the present disclosure is directed to a non-transitory, computer-readable medium. The non-transitory, computer-readable medium can include instructions that, when executed by one or more processors, cause the one or more processors to perform a process. The process can include performing vividness scoring for a plurality of pixels of the digital image, determining one or more candidate pixels based on the vividness scoring for the plurality of pixels, and agglomerating the one or more candidate pixels into one or more suggested agglomerates. The process can also include determining at least one subject of the digital image, removing at least one agglomerate from the one or more suggested agglomerates based on at least one of the at least one subject of the digital image or one or more characteristics of the at least one agglomerate, generating a modified digital image with the one or more suggested agglomerates modified, and outputting the modified digital image.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs image modification according to example embodiments of the present disclosure.

FIG. 1B depicts a block diagram of an example computing device that performs image modification according to example embodiments of the present disclosure.

FIG. 1C depicts a block diagram of an example computing device that performs image modification according to example embodiments of the present disclosure.

FIG. 2 depicts an example system according to an example embodiment of the present disclosure.

FIG. 3 depicts a flow chart of a method for modifying an image according to example embodiments of the present disclosure.

FIG. 4A depicts a mapping between color channels of an image and a colorfulness score according to an example embodiment of the present disclosure.

FIG. 4B depicts a determination of mask pixels according to an example embodiment of the present disclosure.

FIG. 4C depicts a determination of one or more super-pixels from a candidate pixels mask according to an example embodiment of the present disclosure.

FIG. 4D depicts an agglomeration of pixels according to an example embodiment of the present disclosure.

FIG. 4E depicts agglomerate filtering according to an example embodiment of the present disclosure.

FIG. 4F depicts a determination of one or more splotchy regions in an image according to an example embodiment of the present disclosure.

FIG. 4G depicts a determination of one or more agglomerations for modification according to an example embodiment of the present disclosure.

FIG. 4H depicts a subject determination model according to an example embodiment of the present disclosure.

Reference numerals that are repeated across plural figures are intended to identify the same features in various implementations.

### DETAILED DESCRIPTION

### Overview

Generally, the present disclosure is generally related to improving digital photos by modifying distractive colorful regions of photos. In particular, aspects of the present disclosure are related to automatically identifying vivid regions of digital images that distract attention away from subjects of the digital image. The distractiveness of the identified regions can then be reduced (e.g., recolorization of the corresponding pixels to have pixel colors that are less distracting or salient). Identification and modification of distractive regions can be performed by scoring the vividness of pixels in the digital image, identifying regions of vivid pixels, and modifying the regions of vivid pixels via various image modification techniques. In some implementations, regions can be modified so long as the regions of vivid pixels meet certain criteria and/or do not overlap the subject of the image.

More particularly, in order to identify vivid regions of color in a digital image for removal or other modification, vividness scoring for each pixel in the digital image can be performed. Vivid pixels, or pixels with characteristics placing the pixel above a threshold, can then be grouped into candidate groups of pixels and agglomerated into regions of the digital image deemed to be “vivid,” “bright,” or another indicator that the region is somehow distracting or undesirably salient in the digital image.

Next, a subject of the image (such as a center of the image or one or more human subjects located within the image) can be identified. If any of the identified regions overlap the subject of the image or otherwise do not meet certain characteristics, such as minimum average brightness or minimum size of agglomeration in pixels, the identified regions, or agglomerations, can be removed from a list of suggested agglomerations for removal or modification from the digital image. After these identified agglomerations are determined and kept, the remaining suggested agglomerations can be modified in the digital image using image processing and manipulation techniques, which results in a reduction in distracting regions of the image that are not the subject of the image.

In some implementations, in order to determine the subject of the image, an artificial intelligence model can be used to take gaze data or image data as input and output a probability of a region of an image being the subject of the image.

Aspects of the present disclosure improve upon current image segmentation and modification. First, regions that may be easily identifiable to the human eye as “too vivid,” but that do not allow humans to delineate the too-vivid regions from non-vivid regions at the per-pixel level, can be identified and modified or otherwise reduced in vividity to make those regions in the digital image less distracting. Second, vivid regions that overlap a subject of the picture (e.g., a person wearing bright clothing) can be identified and not modified while vivid regions in locations other than the subject can be modified, thus removing distractions that take attention away from the subject of the image, while retaining the original depiction of the subject of the image. This enables users to create more desirable images automatically without having to manually edit images and do a per-pixel analysis to determine which sets of pixels to remove or otherwise modify.

Additionally, this method of segmenting images focuses on vivid regions of pixels instead of segmenting at the object level (e.g., segmenting images to identify objects such as a cup, a tree, or a shirt). For example, a shirt may have a pattern that includes alternating vivid and non-vivid colors. Typical segmentation methods will only identify the entire shirt as an object. In contrast, the present method of segmentation will only segment the vivid pixels that are to be modified, such as stripes or other areas of the shirt that are too vivid.

With reference now to the Figures, example embodiments of the present disclosure will be discussed in further detail.

### Example Devices and Systems

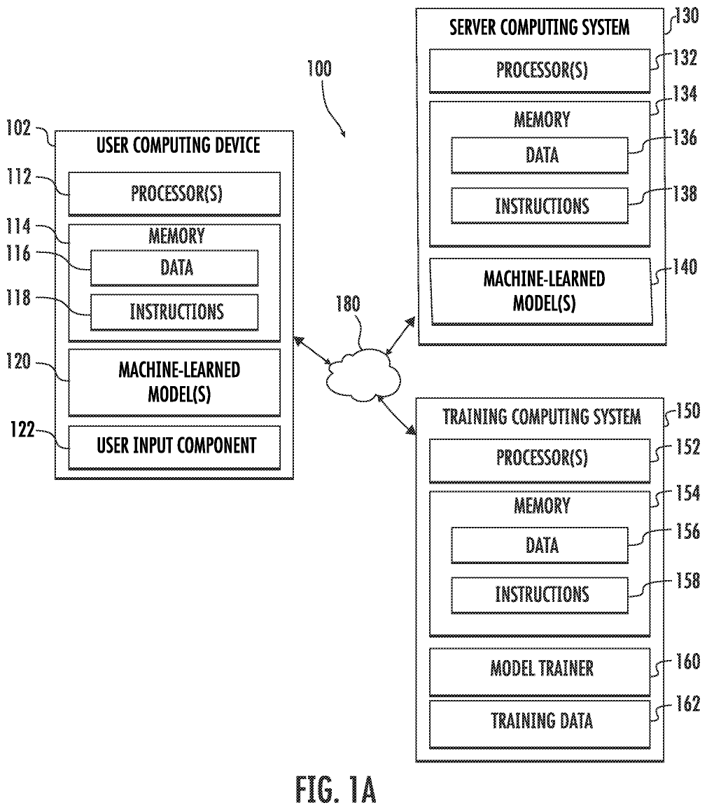

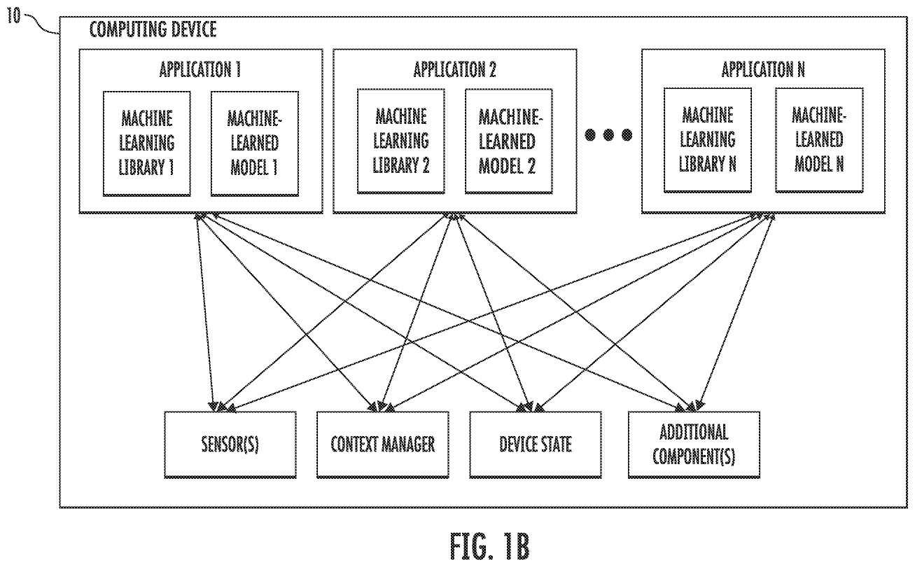

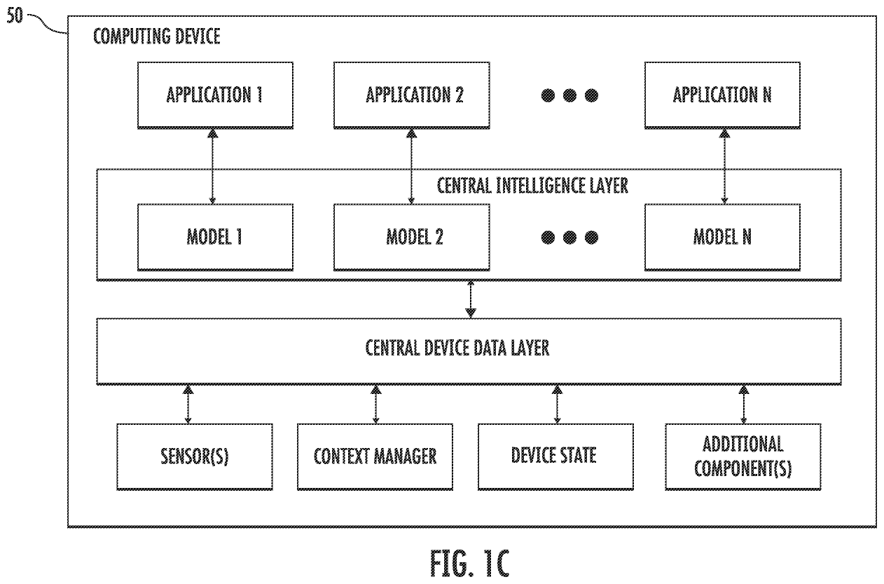

FIG. 1A depicts a block diagram of an example computing system 100 that performs image modification according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more subject determination models 120. For example, the subject determination models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). In one embodiment, the subject determination models 120 can include a multi-branch U-net architecture model that includes a pre-trained classification backbone network and a saliency heatmap prediction network.

In some implementations, the one or more subject determination models 120 can be received from the server computing system 130 over network 180, stored in the user computing device memory 114, and then used or otherwise implemented by the one or more processors 112. In some implementations, the user computing device 102 can implement multiple parallel instances of a single subject determination model 120 (e.g., to perform parallel subject determinations across multiple instances of subject determination).

More particularly, the subject determination model can identify subjects of the image, the subjects being persons or non-persons. It is desirable to not modify pixels that are considered to show the subject of the image, as keeping those pixels “vivid” or otherwise unchanged help to accentuate the subject in the image. Various methods can be used by the subject determination model to determine what the subject of the image is, such as using image masks for persons, using heuristics for regions in the center of the image, and/or using saliency-based modeling.

For example, if there are no people subjects in the image, the subject determination model can utilize a heuristic approach to generate bounding boxes for various detected objects in the image. The subject determination model can then determine which bounding boxes are within a threshold distance of a center of the image. Objects or regions covered by these determined bounding boxes can then be identified as regions to not modify, as the proximity of these objects or regions to the center of the image can indicate that the objects or regions are possible subjects of the image. These objects or regions can then be removed from consideration for brightness or vividness modification.

In another example, a saliency approach can be used to identify a subject of an image. Intuitively, persons viewing images will have their attention, and therefore their gaze, directed to major subjects in the image quickly after viewing the image. Furthermore, their attention and gaze will remain on major subjects in the image for a greater amount of time than other portions of the image. Therefore, the subject determination model can utilize gaze data for various images to obtain ground-truth gaze data on major subjects in images. This gaze data can include gaze temporal data, indicating where early gazes are focused on the image, and gaze spatial data, in which dense gaze data (e.g., portions of the image the person spent the most time looking at) can be used. The output of the saliency model can include a heatmap representing a probability of one or more portions of the digital image containing a subject of the image. The subject determination model can determine one or more subjects of the image and then remove the portions of the image containing the subjects from consideration for modification.

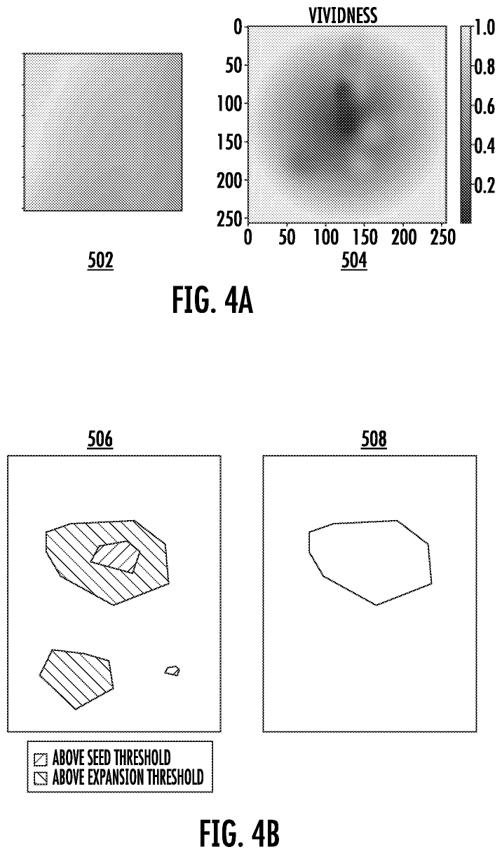

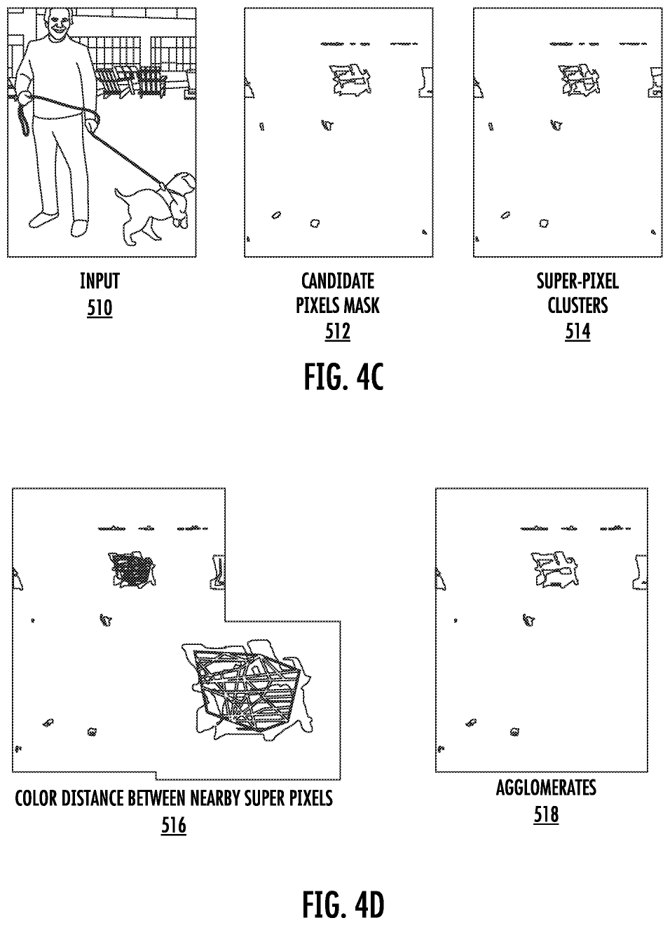

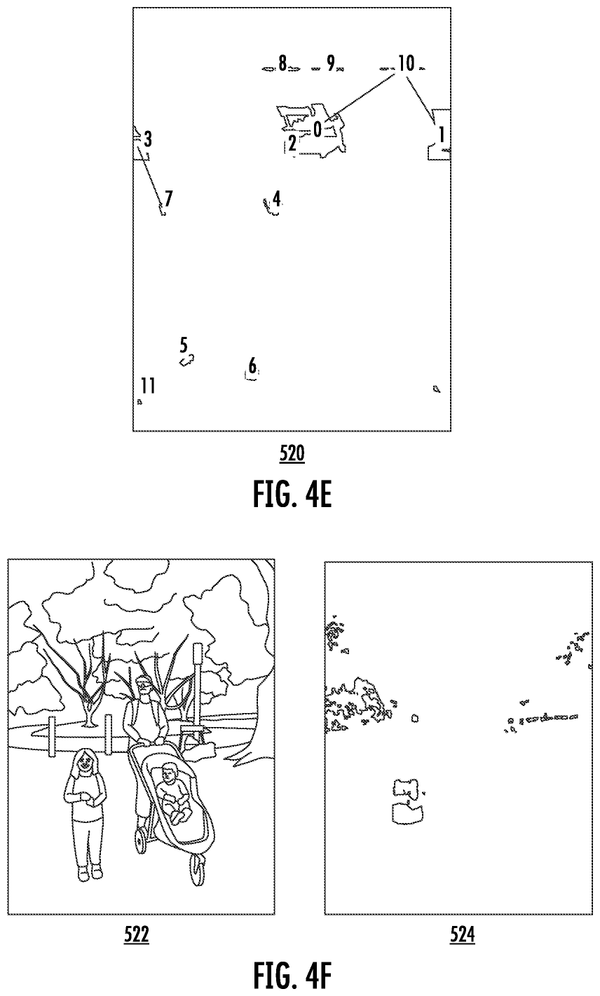

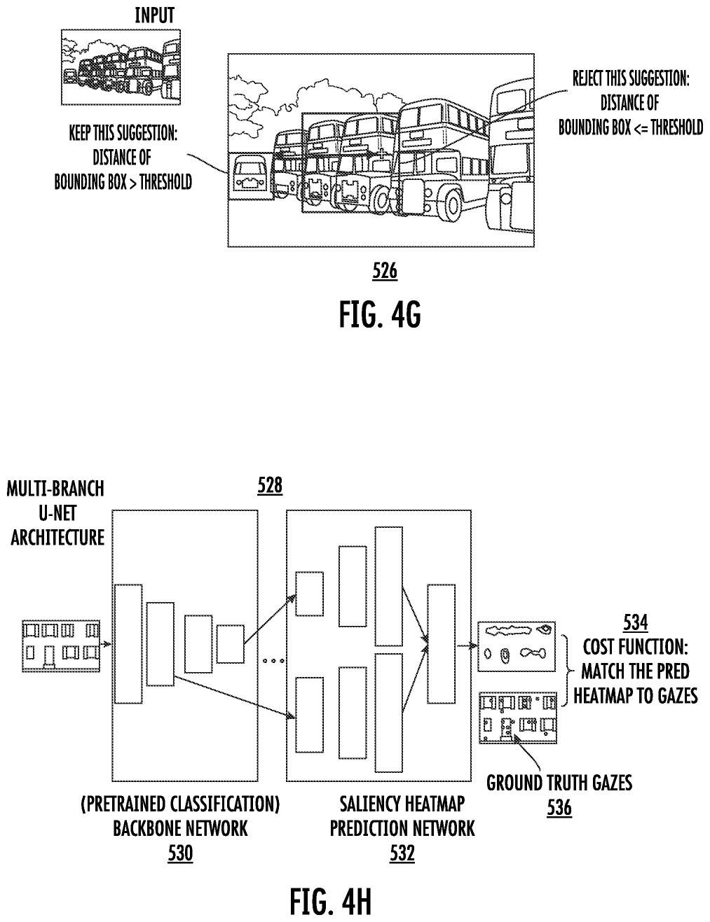

In some embodiments, the subject determination model can utilize image segmentation to identify objects, persons, or other regions within images. In a person masking approach, the subject determination model can use image segmentation to identify one or more persons in the image and generate a mask for the image, such that the mask for the image identifies regions in which the one or more persons are present and removes said regions from consideration for modification to reduce brightness or vividness. In a heuristic approach, the subject determination model can use image segmentation to identify one or more object or regions in the image and then generate bounding boxes for said objects or regions. In a saliency approach, after identifying subjects portions of the images that contain major subjects, the subject determination model can perform image segmentation to separate the subjects from the remaining portions of the image. An example of a subject determination model 528 can be found in FIG. 4H. In one embodiment, the subject determination model 528 can include a pretrained classification backbone network 530 and a saliency heatmap prediction network 532. The two networks can be used along with a cost function 534 that can, for example, match a predicted heatmap to ground truth gaze data 536 to determine saliency in an image. In a different embodiment, subject determination model 528 can be a foreground image segmentation model trained using images with manually labeled objects considered to be in the foreground of the image.

Additionally or alternatively, one or more subject determination models 140 can be included in or otherwise stored and implemented by the server computing system 130 that communicates with the user computing device 102 according to a client-server relationship. For example, the subject determination models 140 can be implemented by the server computing system 140 as a portion of a web service (e.g., an image modification service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

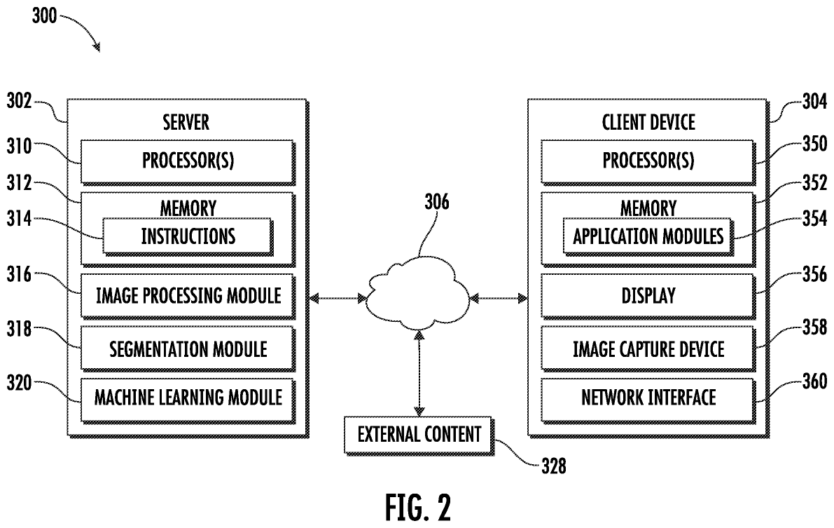

As described above, the server computing system 130 can store or otherwise include one or more subject determination models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some embodiments, the loss function can include a normalized scanpath saliency loss function, an AUC loss function, and the like.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the subject detection models 120 and/or 140 based on a set of training data 162. The training data 162 can include, for example, different types of data depending on which types of approaches are used for subject determination. In one embodiment, the training data can include a plurality of training images that contain one or more persons, such that the subject determination models 120 and/or 140 can be trained to detect when persons are present in the image. In another embodiment, the training data can include a plurality of training images that contain various objects or segmented portions of images, such that the subject determination models 120 and/or 140 can be trained to detect one or more distinct objects, regions, or other portions of images, especially those objects, regions, or other portions located proximate to a center of the image. In a further embodiment, the training data can include a plurality of images with filtered ground-truth gaze points, such that the subject determination models 120 and/or 140 can be trained to detect one or more portions of the image in which gazes of viewers of images are directed and, subsequently, identify these portions of the image as major subjects of the image.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

Figure 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 2 depicts an example system 300 according to an example embodiment of the present disclosure. System 300 can include a client-server architecture, where a server 302 communicates with one or more computing devices 304 over a network 306. Although one computing device 304 is illustrated in FIG. 1, any number of computing devices can be connected to server 302 over network 306.

Computing device 304 can be, for example, a computing device having a processor 350) and a memory 352, such as a wireless mobile device, a personal digital assistant (PDA), smartphone, tablet, laptop computer, desktop computer, computing-enabled watch, computing-enabled eyeglasses, gaming console, embedded computing system, or other such devices/systems. In short, computing device 304 can be any computer, device, or system that can interact with the server system 302 (sending and receiving data) to implement the present disclosure.

Processor 350 of computing device 304 can be any suitable processing device and can be one processor or a plurality of processors that are operably connected. Memory 352 can include any number of computer-readable instructions or other stored data. In particular, memory 352 can include, store, or provide one or more application modules 354. When implemented by processor 350, application modules 354 can respectively cause or instruct processor 350 to perform operations consistent with the present disclosure, such as, for example, performing subject determination and image modification. Other modules can include a virtual wallet application module, a web-based email module, a game application module, or other suitable application modules.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example, computer executable instructions that are stored in a tangible computer-readable storage medium such as RAM hard disk or optical or magnetic media.

Computing device 304 can include a display 356. Display 356 can be any suitable component(s) for providing a visualization of information, including, for example, touch-sensitive displays (e.g. resistive or capacitive touchscreens), monitors, LCD screens, LED screens (e.g. AMOLED), or other display technologies.

Computing device 304 can further include an image capture device 358. The image capture device 358 enables the computing device 304 to capture images for later analysis and modification. For example, communication module 358 can include a camera and/or other suitable components for enabling a user to capture images for later analysis and modification from the computing device 304.

Computing device 304 can further include a network interface 360. Network interface 360 can include any suitable components for interfacing with one more networks, including for example, transmitters, receivers, ports, controllers, antennas, or other suitable components.

Server 302 can be implemented using one or more suitable computing devices and can include a processor 310 and a memory 312. For example, server 302 can be one server computing device or can be a plurality of server computing devices that are operatively connected. In the instance that server 302 includes a plurality of server computing devices, such plurality of server computing devices can be organized into any suitable computing architecture, including parallel computing architectures, sequential computing architectures, or some combination thereof.

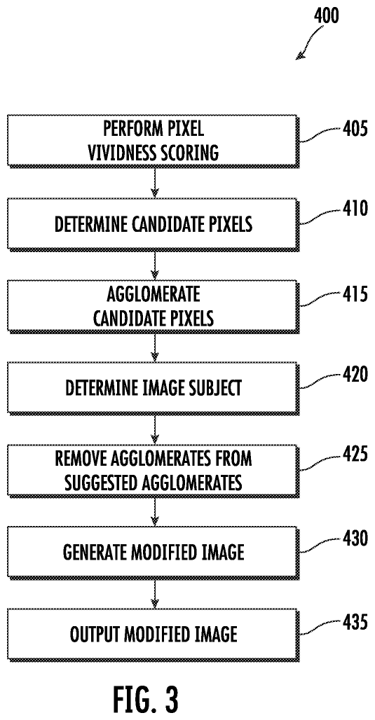

Processor 310 can be any suitable processing device and can be one processor or a plurality of processors which are operably connected. Memory 312 can store instructions 314 that cause processor 310 to perform operations to implement the present disclosure, including performing aspects of method (500) of FIG. 3.

Server 302 can include one or more modules for providing desired functionality. For example, server 302 can include a image processing module 316, a segmentation module 318, and a machine learning module 320.

Server 302 can implement image processing module 316 to provide subject determination and image modification for the server 302. For example, image processing module 316 can provide image reception functionality, image pre-processing functionality, image analysis functionality, image modification and manipulation functionality, and other functionality related to the management, modification, storage, reception, and output of images for the server 202.

In some embodiments, image processing module 316 can perform per-pixel vividness analysis on an image by performing a mapping between the CrCb channels of a YCrCb image and a “colorfulness” score. Image process module 316 can start with determining a distance between the (Cr, Cb) value of the pixel and (128, 128), and then can specify a desired “vividness” for example patches to tweak the mapping for the colors in the patch. Based on the distance and the vividness of the pixel, a pixel colorfulness and uniqueness can be determined. In some embodiments, both the colorfulness and uniqueness can be a score between 0 and 1. Uniqueness of a pixel is a measure of how unique a (Cr, Cb) value is in an image, such that the most common (Cr, Cb) value of the image has a uniqueness of 0) and the least common (Cr, Cb) value has a uniqueness of 1. Uniqueness can be determined by creating a normalized two-dimensional histogram of (Cr, Cb) values of pixels in the image. In some embodiments, the histogram can be filtering using, for example, a Gaussian filter, and then inputting the filtered values into a function that makes the largest histogram value have a uniqueness of 0 and the smallest non-zero histogram value have a uniqueness value of 1.

The colorfulness value can be determined by computing a 2-D lookup table for all values of (Cr, Cb). The values in the lookup table can be determined by initializing the values with a function of the distance from the center, or a (Cr, Cb) of (128, 128). The center of (128, 128) can then be set to a colorfulness of 0 and the colorfulness value can then grow linearly with the distance of a particular (Cr, Cb) value from (128, 128) such that the colorfulness is 1 when the distance is equal to or greater than 128. In some embodiments, colorfulness values can be modified based on selected patches of example image pixels and desired colorfulness values. For example, colorfulness values at table locations associated with the (Cr, Cb) values of the selected patches of pixels can be modified such that the colorfulness values are a weighted average of the distance based colorfulness value and the desired colorfulness value. Image processing module 316 can provide these colorfulness values and uniqueness values for each pixel or group of pixels to the server 302, which in turn can provide the values to other modules, such as segmentation module 318, for processing.

In another embodiment, an identified value (Cr, Cb) of the pixel can be associated with a mapping. For example, based on the identified value (Cr, Cb) of the pixel, a mapping, a look-up table, or other data structure can be accessed and a colorfulness value associated with the identified value can be retrieved and provided as the colorfulness value for the pixel. An example of a mapping between color channels of an image and a colorfulness score can be found in FIG. 4A. For example, in FIG. 4A, a test color image 502 can be analyzed and a resulting vividness image 504 can be determined.

In some embodiments, image processing module 316 can perform agglomerate filtering. As described below in relation to segmentation module 318, groups of pixels can be agglomerated into one or more agglomerations of pixels that have a similar colorfulness value and are in regions of similar uniqueness (e.g., a group of pixels that have the same color as other pixels in the group but are unique compared to pixels surrounding the group of pixels). Image processing module 316 can determine which agglomerations should be kept as suggestions for modification, such as reduction in brightness. Image processing module 316 can perform agglomerate filtering in various ways, such as comparing average vividness to a vividness threshold, comparing an area of the agglomerate to minimum and maximum area thresholds, comparing a “splotchiness” of the agglomerate to a threshold, or comparing a location of the agglomerate to location criteria.

Splotchiness can be a metric that captures irregularity in shape of an agglomerate. In some embodiments, splotchiness can be computed using Equation 1.

$$c = \frac{AREA ( CLOSE ( mask , {k}_{r} ) - AREA ( mask ) )}{AREA ( maks )} \qquad Equation 1$$

This calculated splotchiness can be compared to a splotchiness threshold. For example, if the splotchiness value calculated is less than the threshold, the agglomerate can be recommended to be kept for modification. An example of a determination of one or more splotchy regions in an image can be found in FIG. 4F. In FIG. 4F, an input image 522 can be analyzed for splotchiness and a resulting splotchiness output 524 can be produced identifying splotchy regions of the input image 522.

Other examples of agglomerates to be kept for modification can include determining that an area of an agglomerate is greater than a minimum required area for modification but less than a maximum area for modification and determining than an average vividness or colorfulness of an agglomerate is greater than a specified vividness or colorfulness threshold.

In some embodiments, agglomerate filtering can include comparing a location of the agglomerate to location criteria. Location criteria can include proximity to a center of the image, being proximately located and/or overlapping one or more subjects (e.g., objects, persons, etc.) of an image, and the like. As described both above in relation to FIG. 1A and below in relation to machine learning module 320, a location of objects or subjects can be determined in various ways. Based on the location of these objects or subjects and the locations of the agglomerates, one or more agglomerates can be determined to be kept for modification or removed from consideration for modification. For example, if a vivid agglomerate overlaps a subject of an image, image processing module 316 can determine that the vivid region should be kept unmodified. An example of agglomerate filtering can be found in FIG. 4E. In FIG. 4E, particular regions of an agglomerate image 520 can be removed from consideration for modification based on the various criteria discussed above. An example of a determination of one or more agglomerations for modification can be found in FIG. 4G. For example, various regions in agglomeration image 526 can be highlighted, for example, by bounding boxes. Based on the location(s) of these regions in the agglomeration image 526, one or more of these regions can be considered for removal based on the one or more criteria discussed above.

Server 302 can implement segmentation module 318 to perform image segmentation on images received by the server 302. For example, segmentation module 318 can utilize image segmentation to identify objects, persons, or other regions within images. In a person masking approach, segmentation module 318 can use image segmentation to identify one or more persons in the image and generate a mask for the image, such that the mask for the image identifies regions in which the one or more persons are present and generates a mask for said regions. In a heuristic approach, segmentation module 318 can use image segmentation to identify one or more object or regions in the image and then generate bounding boxes and/or masks for said objects or regions. In a saliency approach, after identifying subjects portions of the images that contain major subjects, segmentation module 318 can perform image segmentation to separate the subjects from the remaining portions of the image by, for example, generating one or more masks for the subject(s).

In some embodiments, segmentation module 318 can perform specific types of image segmentation based on the vividness of portions of the image. For example, based on pixel colorfulness and/or uniqueness values, segmentation module 318 can determine one or more masks for groups of pixels that share similar colorfulness values based on the uniqueness values. The size and shape of the determined masks can be determined by comparing colorfulness or uniqueness of pixels or groups of pixels to surrounding pixels or groups of pixels. In some embodiments, the colorfulness or uniqueness of pixels or groups of pixels to certain thresholds, such as an expansion threshold or a seed threshold. For example, a mask can be determined as a binary mask, where pixels that satisfy the vividness score (the combination of the colorfulness and uniqueness scores) are included in the mask. To determine if the pixels are sufficiently vivid, the vividness score of each pixel can be compared to the expansion threshold and the seed threshold. In some embodiments, the expansion threshold is less than or equal to the seed threshold. In one example, the mask will include all pixels whose vividness score exceeds the expansion threshold value and that are in connected components of the image with pixels whose vividness score exceed the seed threshold. Connected components of the image can be, for example, individual pixels that are connected by a “path” of pixels between the individual pixel and a seed pixel (a pixel with a vividness value that exceeds the seed threshold), where the vividness value of each path pixel is greater than or equal to the expansion threshold. An example of a determination of mask pixels can be found in FIG. 4B. In FIG. 4B, pixels in an image can be grouped by pixels being above an expansion threshold and pixels being above an expansion threshold and being connected to pixels above a seed threshold, such as in pixel mask image 506. In candidate mask image 508, regions that fit certain criteria, such as size of the region of identified pixels, can be illustrated as a set of candidate pixels.

In some embodiments, segmentation module 318 can perform super-pixel clustering to generate super-pixel clusters from the generated masks of pixels. Super-pixel clustering aids in color image segmentation. A super-pixel is a compact set of pixels sharing similar properties, such as colorfulness and location. For example, to obtain a super-pixel, the color and location of all pixels in a mask can be clustered into a number of clusters using k-means clustering. These compact sets of pixels replace the rigid structure of individual pixels by delineating similar regions in the image and creating larger regions for simpler processing than processing pixels on an individual level. Groups of similar pixels or pixel masks can be clustered by iteratively aggregating pixels in a local region of the image. For example, simple linear iterative clustering techniques can be used to create uniform size and compact super-pixels that adequately describe a particular structure within the image. An example of a determination of one or more super-pixels from a candidate pixels mask can be found in FIG. 4C. For example, in FIG. 4C, an input image 510) can be analyzed to produce a candidate pixel mask image 512. The candidate pixels in the candidate pixel mask image 512 can then be grouped into super-pixel clusters, such as in super-pixel cluster image 514.

In some embodiments, segmentation module 318 can perform cluster agglomeration to generate one or more agglomerations of super-pixels. For example, segmentation module 318 can determine a distance between colors of one or more super-pixels and, based on the distances between various super-pixels, agglomerate super-pixels into one or more agglomerations. An example of an agglomeration of pixels can be found in FIG. 4D. For example, in FIG. 4d, a color distance can be determined (such as in distance computation image 516) between one or more super-pixels and resulting agglomerates can be grouped together, such as in resulting agglomerates image 518.

Server 302 can implement a machine learning module 320 to perform machine learning to, among other things, determine one or more subjects of the image. For example, machine learning module 320 can include a subject determination module. The subject determination model can identify subjects of the image, the subjects being persons or non-persons. It is desirable to not modify pixels that are considered to show the subject of the image because the subject of the image is the object or person that the user cares about in the image. In contrast, modifying non-subject objects and regions is desirable because they are not the focus of the image, and can distract from the subject if the objects or regions are too vivid. Various methods can be used by the subject determination model to determine what the subject of the image is, such as using image masks for persons, using heuristics for regions in the center of the image, and/or using saliency-based modeling. Additional details regarding subject determination model(s) can be found above in relation to subject determination model(s) 120 and/or 140.

Server 302 can be coupled to or in communication with one or more databases, including a database providing user data 322, a geographic information system 324, a database containing reviews 326, and external content 328. Although databases 322, 324, 326, and 328 are depicted in FIG. 1 as external to server 302, one or more of such databases can be included in memory 312 of server 302. Further, databases 322, 324, 326, and 328 can each correspond to a plurality of databases rather than a single data source.

User data 322 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. Generally, according to an aspect of the present disclosure, such data can be analyzed to determine various information about the images being analyzed and/or modified.

Importantly, the above provided examples of user data 322 are simply provided for the purposes of illustrating potential data that could be collected, in some embodiments, to determine various information about the images being analyzed and/or modified However, such user data is not collected, used, or analyzed unless the user has consented after being informed of what data is collected and how such data is used. Further, in some embodiments, the user can be provided with a tool to revoke or modify the scope of permissions. In addition, certain information or data can be treated in one or more ways before it is stored or used, so that personally identifiable information is removed or stored in an encrypted fashion.

Computer-based system 300 can further include external content 328. External content 328 can be any form of external content including news articles, webpages, video files, audio files, written descriptions, ratings, game content, social media content, photographs, commercial offers, transportation method, weather conditions, or other suitable external content. Server system 302 and computing device 304 can access external content 328 over network 306. External content 328 can be searched by server 302 according to known searching methods and can be ranked according to relevance, popularity, or other suitable attributes, including location-specific filtering or promotion.

Network 306 can be any type of communications network, such as a local area network (e.g., intranet), wide area network (e.g., Internet), or some combination thereof and can include any number of wired or wireless links. In general, communication between the server 302 and a computing device 304 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Preferably, however, computing device 304 can freely move throughout the world and communicate with server 302 in a wireless fashion.

### Example Methods

FIG. 3 depicts a flow chart of a method 400 for modifying an image according to example embodiments of the present disclosure. Although FIG. 3 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 405, a computing system can perform pixel vividness scoring for a plurality of pixels in a digital image. In some embodiments, per-pixel vividness analysis can be performed on the digital image by performing a mapping between the CrCb channels of a YCrCb image and a “colorfulness” score. The computing system can start with determining a distance between the (Cr, Cb) value of the pixel and (128, 128), and then can specify a desired “vividness” for example patches to tweak the mapping for the colors in the patch. As described above, the colorfulness and uniqueness of individual pixels can be determined. These two scores can be combined, such as by multiplying the two scores together, to obtain a vividness score for each pixel.

In some embodiments, performing vividness scoring for the plurality of pixels can include determining if a colorfulness value of a pixel in the plurality of pixels is greater than or equal to a colorfulness threshold, a uniqueness value of the pixel is greater than or equal to a uniqueness threshold, or both.

At block 410, the computing system can determine one or more candidate pixels for modification. In some embodiments, determining a set of mask pixels can be determined based on the vividness scoring for the plurality of pixels. In some embodiments, mask pixels are pixels with a vividness score above a first threshold and are pixels connected to pixels with a vividness score above a seed threshold. The pixels determined to be mask pixels are then output as the candidate pixels.

In some embodiments, the computing system can cluster the one or more candidate pixels into one or more super-pixels based on a similar appearance of a subset of the one or more candidate pixels. The computing system can output the one or more super-pixels as the one or more candidate pixels for agglomeration.

At block 415, the computing system can agglomerate the one or more candidate pixels into one or more suggested agglomerates. In some embodiments, one or more super-pixels can be agglomerated into the agglomerates.

At block 420, the computing system can determine an image subject of the image. In some embodiments, the computing system can use machine learning to, among other things, determine one or more subjects of the image. For example, the computing system can use a subject determination model to identify subjects of the image, the subjects being persons or non-persons. It is desirable to not modify pixels that are considered to show the subject of the image, as keeping those pixels “vivid” or otherwise unchanged help to accentuate the subject in the image. Various methods can be used by the subject determination model to determine what the subject of the image is, such as using image masks for persons, using heuristics for regions in the center of the image, and/or using saliency-based modeling. Additional details regarding subject determination model(s) can be found above in relation to subject determination model(s) 120 and/or 140.

In other embodiments, if there are no people subjects in the image, the subject determination model can utilize a heuristic approach to generate bounding boxes for various detected objects in the image. The subject determination model can then determine which bounding boxes are within a threshold distance of a center of the image. Objects or regions covered by these determined bounding boxes can then be identified as regions to not modify, as the proximity of these objects or regions to the center of the image can indicate that the objects or regions are possible subjects of the image. These objects or regions can then be removed from consideration for brightness or vividness modification.

At block 425, the computing system can remove at least one agglomerate from the one or more suggested agglomerates based on at least one of the at least one subject of the digital image and one or more characteristics of the at least one agglomerate. In some embodiments, the one or more characteristics includes at least one characteristic selected from the group of characteristics consisting of average vividness, agglomerate size, agglomerate splotchiness, and agglomerate location. For example, agglomerate filtering can include comparing a location of the agglomerate to location criteria. Location criteria can include proximity to a center of the image, being proximately located and/or overlapping one or more subjects (e.g., objects, persons, etc.) of an image, and the like. A location of objects or subjects can be determined in various ways. Based on the location of these objects or subjects and the locations of the agglomerates, one or more agglomerates can be determined to be kept for modification or removed from consideration for modification. For example, if a vivid agglomerate overlaps a subject of an image, the computing system can determine that the vivid region should be kept unmodified.

At block 430, the computing system can generate a modified image based on remaining agglomerates. For example, the computing system can generate a modified image with areas of the image associated with the remaining agglomerates having reduced colorfulness, brightness, vividness, and the like.

At block 435, the computing system can output the modified image. For example, the modified image can be output for display on a display of the computing system, to a database for storage, and the like.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for modifying a digital image, the method comprising:
performing vividness scoring for a plurality of pixels of the digital image;
determining one or more candidate pixels based on the vividness scoring for the plurality of pixels;
agglomerating the one or more candidate pixels into one or more suggested agglomerates;
determining at least one subject of the digital image;
removing at least one agglomerate from the one or more suggested agglomerates based on at least one of the at least one subject of the digital image or one or more characteristics of the at least one agglomerate;
generating a modified digital image with the one or more suggested agglomerates modified; and
outputting the modified digital image.

2. The method of claim 1, wherein performing vividness scoring for the plurality of pixels includes accessing a mapping between an identified value for each of the plurality of pixels and an associated colorfulness value.

3. The method of claim 1, wherein determining the candidate pixels comprises:
determining a set of mask pixels based on the vividness scoring for the plurality of pixels, wherein mask pixels are pixels with a vividness score above a first threshold and are pixels connected to pixels with a vividness score above a seed threshold; and
outputting the set of mask pixels as the one or more candidate pixels.

4. The method of claim 1, wherein agglomerating the one or more candidate pixels further comprises:
clustering the one or more candidate pixels into one or more super-pixels based on a similar appearance of a subset of the one or more candidate pixels; and
outputting the one or more super-pixels as the one or more candidate pixels for agglomeration.

5. The method of claim 1, wherein determining at least one subject of the digital image includes determining if the digital image includes at least one human subject.

6. The method of claim 5, wherein determining at least one subject of the digital image comprises, when the image contains no human subjects, identifying a center of the digital image as the subject of the digital image.

7. The method of claim 6, wherein removing the at least one agglomerate from the one or more suggested agglomerates includes removing agglomerates with a bounding box within a threshold distance of the center of the image from the suggested agglomerates.

8. The method of claim 5, wherein determining at least one subject of the digital image if the image includes:
collecting gaze data associated with the digital image;
performing filtering on the gaze data, wherein filtering the gaze data includes at least one of determining early gaze data for the digital image and determining dense gaze data for the digital image; and
determining the subject of the digital image based on the gaze data.

9. The method of claim 5, wherein determining the subject of the digital image based on the gaze data includes:
inputting the digital image into a saliency-based artificial intelligence model, the saliency-based artificial intelligence model being trained with images with filtered ground-truth gaze points;
receiving an output from the saliency-based artificial intelligence model, the output including a heatmap representing a probability of one or more portions of the digital image containing the subject of the image; and
determining the subject of the digital image based on the heatmap.

10. The method of claim 1, wherein the one or more characteristics includes at least one characteristic selected from the group of characteristics consisting of average vividness, agglomerate size, agglomerate splotchiness, and agglomerate location.

11. The method of claim 10, wherein agglomerate splotchiness is a metric describing the regularity or irregularity of a shape of the agglomerate.

12. A non-transitory, computer-readable medium comprising instructions that, when executed by one or more processors, cause the one or more processors to perform a process, the process comprising:
performing vividness scoring for a plurality of pixels pixel of a digital image;
determining one or more candidate pixels based on the vividness scoring for the plurality of pixels;
agglomerating the one or more candidate pixels into one or more suggested agglomerates;
determining at least one subject of the digital image;
removing at least one agglomerate from the one or more suggested agglomerates based on at least one of the at least one subject of the digital image or one or more characteristics of the at least one agglomerate;
generating a modified digital image with the one or more suggested agglomerates modified; and
outputting the modified digital image.

13. The non-transitory, computer-readable medium of claim 12, the process further comprising:
determining a set of mask pixels based on the vividness scoring for the plurality of pixels, wherein mask pixels are pixels with a vividness score above a first threshold and are pixels connected to pixels with a vividness score above a seed threshold; and
outputting the set of mask pixels as the one or more candidate pixels.

14. The non-transitory, computer-readable medium of claim 12, the process further comprising:
clustering the one or more candidate pixels into one or more super-pixels based on a similar appearance of a subset of the one or more candidate pixels; and
outputting the one or more super-pixels as the one or more candidate pixels for agglomeration.

15. The non-transitory, computer-readable medium of claim 12, wherein determining at least one subject of the digital image includes determining if the digital image includes at least one human subject.

16. The non-transitory, computer-readable medium of claim 12, wherein the one or more characteristics includes at least one characteristic selected from the group of characteristics consisting of average vividness, agglomerate size, agglomerate splotchiness, and agglomerate location.

17. A computing system for modifying a digital image, the computing system comprising:
one or more processors; and
a non-transitory, computer-readable memory comprising instructions that, when executed by the one or more processors, cause the one or more processors to perform a process, the process comprising:
performing vividness scoring for a plurality of pixels of the digital image;
determining one or more candidate pixels based on the vividness scoring for the plurality of pixels;
agglomerating the one or more candidate pixels into one or more suggested agglomerates;
determining at least one subject of the digital image;
removing at least one agglomerate from the one or more suggested agglomerates based on at least one of the at least one subject of the digital image or one or more characteristics of the at least one agglomerate;
generating a modified digital image with the one or more suggested agglomerates modified; and
outputting the modified digital image.

18. The computing system of claim 17, the process further comprising:
determining a set of mask pixels based on the vividness scoring for the plurality of pixels, wherein mask pixels are pixels with a vividness score above a first threshold and are pixels connected to pixels with a vividness score above a seed threshold; and
outputting the set of mask pixels as the one or more candidate pixels.

19. The computing system of claim 17, the process further comprising:
clustering the one or more candidate pixels into one or more super-pixels based on a similar appearance of a subset of the one or more candidate pixels; and
outputting the one or more super-pixels as the one or more candidate pixels for agglomeration.

20. The computing system of claim 17, wherein determining at least one subject of the digital image includes determining if the digital image includes at least one human subject.
